(19) United States
(12) Patent Application Publication
(10) Pub. No.: US 2010/0275008 A1
(43) Pub. Date: Oct. 28, 2010

(54) METHOD AND APPARATUS FOR SECURE PACKET TRANSMISSION

(75) Inventor: LARRY MURRILL, SCHAUMBURG, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/731,220

(22) Filed: Mar. 25, 2010

Related U.S. Application Data
(60) Provisional application No. 61/173,182, filed on Apr. 27, 2009.

(51) Int. Cl. H04L 29/06

(52) U.S. Cl. 713/153; 713/162

(57) ABSTRACT

A source endpoint includes a security association database; a processing device and an interface operatively coupled to: receive a first packet requiring security processing; retrieve from the first packet a destination endpoint data address for a destination endpoint that is to receive the first packet; determine an address translation; apply the address translation to the retrieved destination endpoint data address to generate a destination endpoint security address, and create an entry in a storage device, wherein the entry corresponds only to the destination endpoint and comprises the generated destination endpoint security address and a set of security parameters. The source endpoint further indexes the storage device to obtain the security parameters for security processing of the first packet to generate a secured first packet; and sends the secured first packet to the destination endpoint.

### TECHNICAL FIELD

The technical field relates generally to secure transmission of packets in a communication system and more particularly to a method and apparatus that dynamically determines addresses for encryption endpoints in order to build a security association database to enable the secure transmission of the packets in the communication system.

### BACKGROUND

In many instances today, when a source endpoint sends information to a destination endpoint, the information may travel through an unprotected network such as the Internet. Depending on the nature of the information, it may need to be secured in one or more ways. For example, the endpoints may implement one or more core security services, such as confidentiality, authentication, etc., wherein confidentiality (e.g., the use of encryption/decryption algorithms) provides information privacy and is applied to the information so that it is understandable only by the intended recipient, and authentication is a process that evaluates the genuineness of the originator and recipient of the information.

A number of existing security protocols can be used to provide the core security services. One such suite of protocols is Internet Protocol Security (IPsec) defined in a number of standards documents specified by the Internet Engineering Task Force (IETF). In accordance with these existing protocols, including IPsec, in order for an endpoint to protect the information that it sends to another endpoint (or conversely in order to receive and decrypt protected information from an endpoint) a security association (SA) must be established. A SA, as the term is used herein, comprises elements that describe protocols and parameters (such as keys and algorithms) used by an endpoint to secure information or traffic flowing in one direction. Therefore, in normal bi-directional traffic, the flows are secured by a pair of SAs. The SA elements are stored in a security association database (SAD). These SA elements include for example, but are not limited to, a security parameter index, a source address, a destination address, security parameters such as a security protocol identifier (ID), one or more key IDs, one or more algorithm IDs, etc., that enable an endpoint to determine how to encrypt/decrypt and/or authenticate information sent to or from another endpoint.

There are two methods for provisioning SAs into an endpoint. The first method is manual provisioning, e.g., using a key variable loader (KVL). However, this method is only practical when there are a limited number of SA elements to be provisioned and when those elements do not change over time. However, many systems are configured with an infrastructure endpoint (e.g., a server or a gateway) that communicates with hundreds or even thousands of endpoints (e.g., subscriber units, computer terminals, etc.) that have addresses that may change over time, wherein manually provisioning the infrastructure endpoint with SAs for all of the endpoints in the system is impractical. In these system configurations, the second method of dynamic provisioning is needed.

One such dynamic provisioning method is the implementation of the well known Internet Security Exchange (IKE) protocol defined in Request for Comments (RFC) 4306 published in December 2005, wherein the two endpoints negotiate the SA elements through a message signaling exchange. A drawback of the IKE protocol, however, is that radio frequency resources or bandwidth in the system is adversely affected when there are large numbers of endpoint users in the system due to the number of messages that need to be exchanged to establish all of the SAs. This problem is magnified in systems that use narrowband links. Moreover, when there are large numbers of endpoint users in the system, the SAD in an infrastructure endpoint can quickly become unmanageable.

Thus, there exists a need for a novel method for provisioning an endpoint with SA elements such as destination addresses that can be implemented even in systems that have a large number of endpoint users.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is block diagram of a communication system in accordance with some embodiments.

FIG. 2 is a block diagram of an infrastructure endpoint in accordance with some embodiments.

FIG. 3 is a flow diagram of a method for secure packet transmission in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a source endpoint: receives a packet requiring security processing; retrieves from the packet a destination endpoint data address for a destination endpoint that is to receive the packet; determines an address translation; applies the address translation to the retrieved destination endpoint data address to generate a destination endpoint security address, and creates an entry in a storage device, such as one implemented as a security association database, a data association database, etc., wherein the entry corresponds only to the destination endpoint and comprises the generated destination endpoint security address and a set of security parameters, and wherein the entry is used to obtain the set of security parameters for security processing of the packet to generate a secured packet for sending to the destination endpoint.

This novel SA provisioning technique (which is an alternative provisioning technique to the IKE protocol) dynamically determines addresses (e.g., Internet Protocol (IP) addresses) of security endpoints while using less bandwidth than with the IKE protocol. Moreover, in an embodiment, a more manageable storage device for security or data associations, for example, can be realized since the storage device is populated “just in time” when an entry is needed for security processing of a packet and since it is not necessary to cache entries in the storage device to implement the teachings herein. Those skilled in the art will realize that the above recognized advantages and other advantages described herein are merely illustrative and are not meant to be a complete rendering of all of the advantages of the various embodiments.

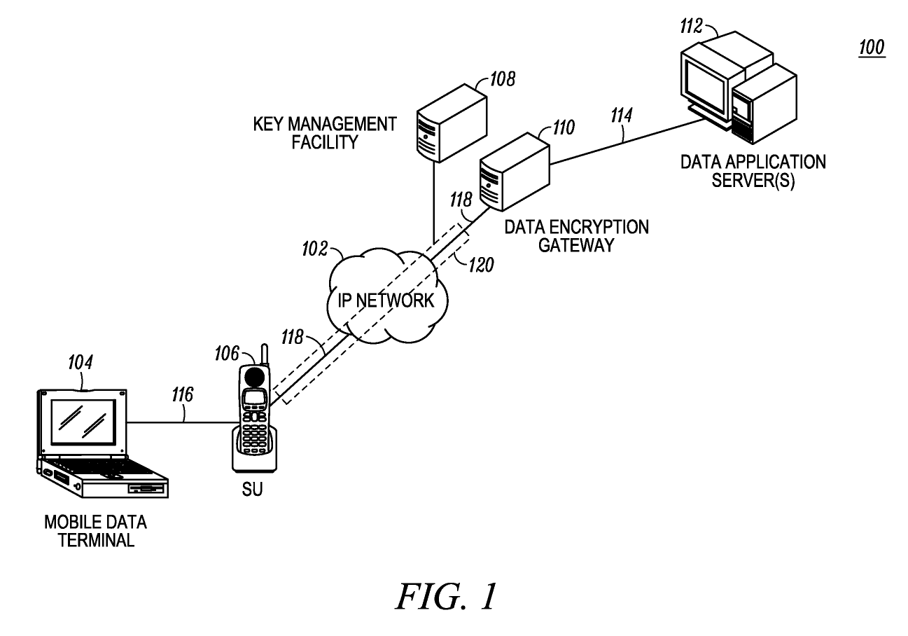

Referring now to the drawings, and in particular FIG. 1, a block diagram of a communication system in accordance with some embodiments is shown and indicated generally at 100. For example, system 100 may be an APCO 25 compliant system or a TETRA compliant system. System 100 comprises a key management facility (KMF) 108, a data encryption gateway (DEG) 110, one or more data application servers (DAS) 112, a mobile data terminal (MDT) 104 and a subscriber unit (SU) 106. For purposes of the teachings herein, we will assume that the MDT 104 and the SU 106 communication with each other in a secured network; therefore a link 116 between the MDT 104 and the SU 106 is an unsecured link, meaning that no security protocol is implemented to send packets on this link. Likewise, the DEG 110 and the DAS(s) 112 communicate with each other in a secured network; therefore a link 114 between the DEG 110 and the DAS(s) 112 is also an unsecured link.

However, when an application on the data application server 112 needs to communicate with an application on the SU 106 or the MDT 104 and vice versa, the packets sent therebetween travel along a path 118 through an unsecure network 102. Therefore, a security protocol is used by devices (e.g., the endpoints 106 and 110) in system 100 to provide security processing in order to generate secured packets that are sent between the devices. In other words, the packets travel within a secure “tunnel” 120 through unprotected network 102, wherein the secure tunnel is created by virtue of the security processing via the application of the selected security protocols.

In this illustrative implementation, network 102 is an internet protocol (IP) network, wherein IPv4 or IPv6 is implemented to enable endpoints to be reachable anywhere within system 100 using IP addresses. Accordingly, security processing is implemented in system 100 using IPsec. Those skilled in the art, however, will recognize and appreciate that the specifics of this example are merely illustrative of some embodiments and that the teachings set forth herein are applicable in a variety of alternative settings. For example, since the teachings described do not depend on the security protocols being used, they can be applied to any type of security protocol wherein security endpoints need to determine the address of other security endpoints in order to build a security association database to implement a security protocol, although a system implementing the IPsec protocol (i.e., IPsec processing) is shown in this embodiment. As such, other alternative implementations of using different types of security protocols are contemplated and are within the scope of the various teachings described.

Additionally, system 100 is shown as having only two mobile devices 104 and 106 and only one KMF 108, DEG 110, and DAS 112 for ease of illustration. However, in an actual system implementation, there is likely hundreds and even thousands of mobile devices that use system 100 to facilitate communications with other mobile and infrastructure devices in system 100. Moreover, the KMF and the DEG each likely serve a number of DASs in the system, and there may further be multiple KMFs and DEGs in an actual system implementation. Also, as used herein, the term packet is defined as a message that contains the smallest unit of media (e.g., data, voice, etc.) sent from a source endpoint to a destination endpoint. A packet containing data as payload is referred to as a data packet, a packet containing voice as payload is referred to as a voice packet. In an IP system, the originating packet further includes an original IP header containing the source endpoint data IP address and the destination endpoint data IP address, and another header if another protocol such as TCP (transmission control protocol) or UDP (user datagram protocol) is used. For the sake of ease of explanation, the media is referred to herein as data and the packet as a data packet, but this is in no way meant to limit the scope of the teachings herein to a particular type of packet being sent between devices in system 100.

The IPsec protocol suite contains two protocols that may be alternatively used for providing core security services. These protocols are Authentication header (AH) defined in RFC 4302 published December 2005 and Encapsulating Security Payload (ESP) defined in RFC 4303 published December 2005. The choice between whether to use the AH or the ESP protocol depends on the particular core security services needed in the system. ESP protocol provides more core security services. More particularly, ESP protocol is used in systems requiring not only integrity and authentication (also provided by AH) but also requiring confidentiality (which is not provided by AH).

Using the AH security protocol, the security endpoint generates an additional header encapsulating and protecting the payload, and the original header stays at the front of the packet, to generate a secured packet. Using the ESP security protocol, the entire original packet including all of the original headers is encapsulated in an ESP header and ESP trailer and a new header is generated and added to the front of the packet, to generate the secured packet.

IPsec also provides for the use of either transport mode or tunnel mode of operation for protecting packets. The choice again depends on the particular system requirements. Although transport mode utilizes a smaller header size, tunnel mode is applicable in the largest number of scenarios since tunnel mode can be used by host equipment (wherein the security processing is co-located in the same device with the application that generates the packets needing security processing) or by gateway equipment (wherein the security processing is provided in a separate device from the application that generates the packets needing security processing).

When the host equipment includes both the application and the security processing functionality, the security processing can be integrated into the single device using an integrated architecture implementation, wherein the security processing is natively in the layer-3 IP layer such as with IPv6; or using a bump in the stack (BITS) architecture that creates a protocol layer, e.g., an IPsec layer, that sits between the layer-3 IP layer and the layer-2 data link layer. The new layer intercepts packets sent down from the IP layer and adds security to them. When a gateway provides the security processing functionality, a bump in the wire (BITW) architecture is realized by a separate device that is placed within strategic points in the network to provide core security services to, for example, entire network segments.

The illustrative system 100 shown in FIG. 1 implements IPsec ESP in tunnel mode, thereby, providing for both host and gateway endpoints. For example, the SU 106 (as a host) provides security processing for applications integrated with the SU itself, such as Global Positioning System (GPS) location. In addition, it provides security processing (as a gateway) to the MDT 104. Thus, data exchanged with a DAS 112 for both purposes is protected by the ESP tunnel 120. Moreover, DEG 110 provides security processing (as a gateway) for the one or more DASs 112. It should be mentioned that although the DEG 110 is shown as physically separate from the DAS 112, in a different embodiment the one or more DAS 112 could each be physically integrated with the DEG functionality using either tunnel or transport mode without departing from the scope of the teachings herein.

Moreover, as the term is used herein, a source endpoint generates originating packets, secures the originating packets, and sends the secured packets through the tunnel to a destination endpoint that processes the secured packet to generate the originating packet for presentation to an application at the intended recipient. Both the source and destination endpoints comprise a data endpoint housing the data application and a security endpoint (or encryption endpoint) performing the security processing, each having an IP address. Thus, a source or destination endpoint may comprise one or two physical devices depending on the particular system implementation. Moreover, the security endpoints (e.g., SU 106 and DEG 110) sit at opposite ends of a security tunnel (e g, tunnel 120). Also, as used herein, the IP address for the source data endpoint is termed a source endpoint data address; the IP address for the source security endpoint is termed a source endpoint security address; the IP address for the destination host endpoint is termed a destination endpoint data address; and the IP address for the destination security endpoint is termed a destination endpoint security address. In the system 100 implementation, many of the IP addresses, especially those associated with the mobile devices in the system, are dynamically provisioned as needed from a pool of available IP addresses and then returned to the pool when no longer needed for communications within the system.

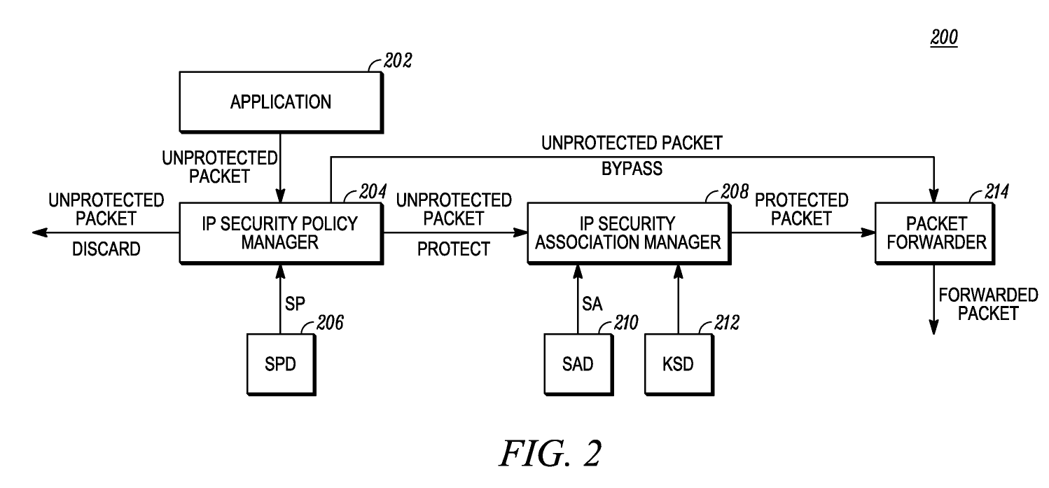

Turning now to FIG. 2, a block diagram of a source endpoint 200 in accordance with some embodiments is shown and generally indicated at 200. Source endpoint 200 comprises a data endpoint having an application 202. Source endpoint 200 further comprises a security endpoint having a security policy manager (SPM) 204 coupled to a security policy database (SPD) 206, a security association manager (SAM) 208 coupled to a SAD 210 and a KSD (key storage database) 212, and a packet forwarder 214. The SAD 210, SPD 206, and KSD 212 databases can be implemented using any suitable form of storage device or memory element such as RAM (random access memory), DRAM (dynamic random access memory), etc., with the entries in these databases also comprising any suitable format, with examples entry formats included in Tables 3-7 below.

The SPM 204 and SAM 208 are illustrated as functional processing blocks that can be implemented using any suitable processing device, such as any one or more of those mentioned below. The packet forwarder 214 comprises an interface for sending the packets over the network 102, with its implementation depending on the source security endpoint and the network 102 implementation used. For example, the packet forwarder 214 may be configured as a wired interface, e.g., an Ethernet connection, and/or a wireless interface comprising a transceiver (receiver and transmitter) and a processing block implementing the relevant wireless interface, e.g., APCO 25, TETRA, 802.11, etc.

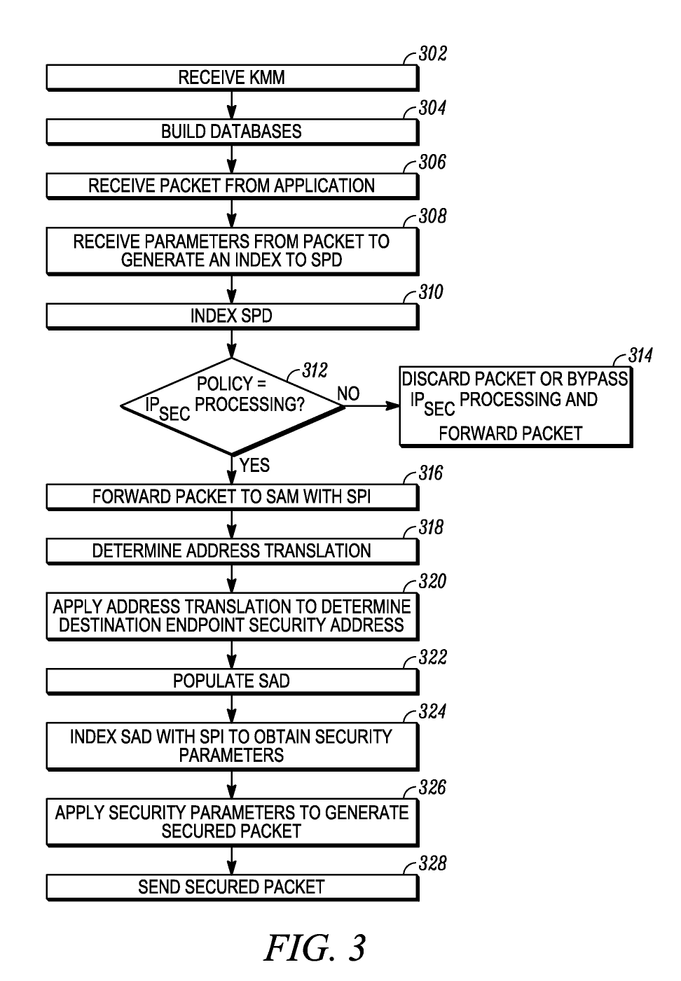

As mentioned above, a SA comprises elements that describe protocols and parameters (such as keys and algorithms) used by an endpoint to secure information or traffic flowing in one direction; and SAs need to be provisioned into the endpoints that provide security processing. FIG. 2 is next described in conjunction with FIG. 3, wherein is explained a method for sending outgoing secured packets in system 100, which includes a method for provisioning the corresponding SAs and building the databases (especially the SAD 210), in accordance with some embodiments.

In an embodiment, some portions of the SAs are provisioned in the source endpoint prior to receiving an outgoing packet from the application 202 needing security processing. These portions of the SAs can be included in a message, termed herein a key management message (KMM) sent (302) to the security endpoint and having a portion of the SA elements used to build (304) the SAD and also elements used to build the SPD in the endpoint. The KMM may take any number of forms and have a variety of information depending on the particular security protocols used in the system. Also, the KMMs may be manually provisioned into the endpoints or dynamically provisioned (other than through the use of IKE in this embodiment), such as by the KMF 108 creating and sending the KMMs to the endpoints over-the-air during a registration process. Table 1 below illustrates information contained in an illustrative embodiment of a KMM, identified by parameter and description of the parameter.

TABLE 1

| Parameter | Description |
|---|---|
| Entry Number | An index number indicating the order in which this |
| | association should be applied |
| Source | Specifies the source endpoint data address or subnet of |
| Endpoint | |
| Data Address | source endpoint data addresses to which this association |
| | applies. |
| Destination | Specifies the destination endpoint data address or subnet |
| Endpoint Data | of destination endpoint data addresses to which this |
| address | association applies. |
| Protocol | Specifies the protocol used by packets to which this |
| | association applies, e.g., ESP or AH. |
| Source Port | Specifies the source port (for protocols that use ports) of |
| | packets to which this association applies. |
| Destination | Specifies the destination port (for protocols that use |
| Port | ports) of packets to which this association applies. |
| Remote Tunnel | Specifies the address translation for determining the |
| Endpoint | destination endpoint security address |
| Storage | Specifies the SLN that should be used with this |
| Location | association. |
| Number (SLN) | |
| Policy | Bypass/discard/process |

The SPD is built (304) using the parameters from the KMM of the source endpoint data address, the destination endpoint data address, the remote tunnel endpoint, the policy (i.e., the security policy), and the SLN. The SAD can be partially built (304) using the parameters from the KMM of the source endpoint data address, the destination endpoint data address, the protocol, and the SLN. More particularly, in one embodiment the endpoint stores (304) the information from the KMM into a data association database (DAD) and uses the information from the data association to build the SPD and the SAD for use in security processing. An additional parameter is included in all three databases that is not included in the KMM, which is the security parameter index (SPI) value, which used is by a security endpoint that encrypts a packet to reference the information in the SAD necessary for encrypting and authenticating the packet.

In IKE processing, the SPI value is a parameter that is negotiated between the security endpoints using the IKE message exchange sequence. However, since IKE is not used in these implementations, another method of determining the SPI value is needed. In order to minimize key management traffic, only one set of SAs for a given type of traffic, specified by IP address, protocol and port, is permitted between two endpoints. This restriction allows all of the tunnel parameters to be determined from the source and destination IP address of the packet being processed, with the exception of the key data. This allows the SPI value to be used only to specify the parameters of the key.

In order to maximize the benefit of the reduced key management traffic associated with the simplified tunnel parameter specification scheme described above, special significance is placed on the SPI value. Since it only specifies the key data, the SPI value is not explicitly provisioned by the key management facility, but rather determined by encoding the Key ID and Algorithm ID of the key used to encrypt the packet into the SPI. In an illustrative example, the SPI field is encoded in the format shown in Table 2 below.

TABLE 2

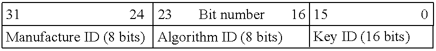

IPSec allows for the use of a variety of encryption and authentication algorithms. The use of these algorithms is determined before the security endpoint begins security processing of any packets. In the illustrative system 100, the KMF 108 handles the coordination of the algorithms used to encrypt and/or authenticate data. In one illustrative example, an algorithm suite represents the set of algorithms that are used by a given IPSec tunnel for both encryption and authentication. A single identifier, represented by an 8-bit Algorithm ID is used to identify an algorithm suite. In addition, a single key ID is used to identify the set of all key data required for use with the algorithm suite. This means that each keyset in an SLN holding keys used with the packet encryption service holds all key material required for both encryption and authentication.

When the key management facility provisions the SAD parameters into an endpoint, it associates an SA with the SLN. Each key in the SLN comprises all of the key data required for both authentication and encryption. The SLN, along with the currently active keyset, is used by the encrypting endpoint to select the key to use when encrypting a packet. As key data changes, the resulting SPI values will change accordingly while the SA continues to be linked to the SLN. The SPI is also included as part of an ESP header so that the destination encryption endpoint can properly index its SAD to decrypt the packet.

Tables 3, 4, 5, 6, and 7 below, respectively, illustrate a KSD arranged by the KMF and a DAD, two SPDs, and a SAD built by the DEG 110 using a KMM received from the KMF. The security endpoints at the mobile device end build similar databases.

TABLE 3
KSD - Key Storage Database

| | Index set/ | Index set/ | Index set/ |
|---|---|---|---|
| CKR/CG | Keyset 1 | Keyset 2 | Keyset 3 |
| 1 | 1111 | 2222 | 3333 |
| 2 | 4444 | 5555 | 6666 |
| | ↑ | | |
| | Active | | |

TABLE 4
DAD—Data Association Database

| SPI | SPC-IP | DST-IP | SRC-IP | DST-IP | Protocol | Enc-CKR | Auth-CKR | Keyset |
|---|---|---|---|---|---|---|---|---|
| 3873455 | 192.168.300.0/24 | 192.168.200.0/24 | 192.168.200.101 | * | ESP | 1 | 2 | 1 |
| 7335774 | 192.168.200.0/24 | 192.168.300.0/24 | * | 192.168.200.101 | ESP | 1 | 2 | 1 |
| 9533566 | 192.168.300.0/24 | 192.168.200.0/24 | 192.168.200.101 | * | ESP | 1 | 2 | 2 |
| 1123578 | 192.168.200.0/24 | 192.168.300.0/24 | * | 192.168.200.101 | ESP | 1 | 2 | 2 |

TABLE 5
SPD—Security Policy Database (when Keyset 1 is Active)

| SRC-IP | DST-IP | Policy | SPI | DST-IP | Protocol |
|---|---|---|---|---|---|
| 192.168.300.0/24 | 192.168.200.0/24 | Process | 3873455 | * | ESP |
| 192.168.200.0/24 | 192.168.300.0/24 | Process | 7335774 | 192.168.200.101 | ESP |

TABLE 6
SPD—Security Policy Database (when Keyset 2 is Active)

| SRC-IP | DST-IP | Policy | SPI | DST-IP | Protocol |
|---|---|---|---|---|---|
| 192.168.300.0/24 | 192.168.200.0/24 | Process | 9533566 | * | ESP |
| 192.168.200.0/24 | 192.168.300.0/24 | Process | 1123578 | 192.168.200.101 | ESP |

TABLE 7
SAD—Security Association Database

| SPI | SRC-IP | DST-IP | Protocol | Enc-Algo | Enc-Key | Auth-Algo | Auth-Key |
|---|---|---|---|---|---|---|---|
| 3873455 | 192.168.200.101 | * | ESP | AES | 1111 . . . | MD5 | 4444 . . . |
| 7335774 | * | 192.168.200.101 | ESP | AES | 1111 | MD5 | 4444 . . . |
| 9533566 | 192.168.200.101 | * | ESP | AES | 2222 . . . | MD5 | 5555 . . . |
| 1123578 | * | 192.168.200.101 | ESP | AES | 2222 . . . | MD5 | 5555 |

Note that the “*” in the databases indicates a translation applied to the destination endpoint data address (e.g., DST-IP) to generate the destination endpoint security address (e.g., DST-IP') used to reach the destination security endpoint (or SU 106 in this case). The illustrative DAD includes the fields of: SPI; SRC-IP (source endpoint data IP address); DST-IP; SRC-IP' (source endpoint security IP address); DST-IP' (which contains the address translation for generating the destination endpoint security IP address); Protocol (security protocol ID); Ecr-CKR (the SLN in the KSD to index an encryption key); Auth-CKR (the SLN in a database (e.g., the KSD or another database to index an encryption key, and Keyset (the index to the active Keyset in the KSD). The illustrative SPDs include the fields of: SRC-IP; DST-IP; Policy; SPI; DST-IP', and Protocol. The illustrative SAD includes the fields of: SPI; SRC-IP'; DST-IP'; Protocol; Enc-Algo (encryption algorithm ID); Enc-Key (encryption key ID); Auth-Algo (authentication algorithm ID); and Auth-Key (authentication key ID).

Now, that the relevant databases themselves are described, the description returns to FIG. 2 and FIG. 3 to explain the processing of outgoing packets in accordance with the teachings herein. When an unprotected packet is received (306) from the application (202), it is first evaluated by the SPM. The SPM 204 retrieves (308) parameters (e.g., the source endpoint data IP address and destination endpoint data IP address), generates a selector tuple <source IP, destination IP> and uses it to index (310) into the SPD to locate a security policy for the packet being evaluated. If (312) a policy cannot be located, the packet is discarded (314). If (312) a policy is located and it indicates that the packet must be discarded, the packet is discarded (314). If (312) the policy indicates that the packet must BYPASS IPsec processing, the packet is forwarded (314) to the network via the packet forwarder 214. Finally, if (312) the policy indicates that the packet must be processed with IPsec, the packet is forwarded (316), along with an SPI (which can be a linked SPI if a partial SAD is generated prior to receiving the packet), to the SAM 208 for processing.

When a packet is received by the SAM 208, it determines (318) an address translation to use with the packet. The address translation may be obtained from the DAD using the pre-linked SPI or may be obtained from the SAD (if a partial SAD exists) using the pre-linked SPI or may be obtained from the SPD. In any case, the SAM applies (320) the address translation to the retrieved destination endpoint data address to obtain the destination endpoint security address needed to create (322) an entry in the SAD specific to the destination endpoint. “Create” may mean creating an entry in an unpopulated SAD for the destination endpoint, wherein the entry has the format of the first entry in the SAD shown in Table 7, except that the DST-IP' field is filled in with the actual destination endpoint security IP address that was generated by SAM. “Create” may, alternatively, mean indexing an entry in the partially populated SAD, and populating the DST-IP' field for that entry. As mentioned earlier, generally SA pairs are created in the SAD (e.g., the first entry in Table 7 for the outgoing traffic, and the second entry in Table 7 for the incoming traffic). The SLN is used to query the KSD to obtain identification of an active encryption and authorization keyset to be used during the security processing.

This SAD entry generation creates a “just-in-time” population (322) of the SAD database that can now be indexed (324) using the SPI to link to the appropriate SA and obtain the security parameters (e.g., the security protocol ID, the encryption algorithm, the encryption key ID, the authentication algorithm ID, and the authentication key ID. The SAM applies (326) the security parameters to the original packet to generate the new header and the ESP header and trailer having a format defined in RFC 4303 and to encrypt the encapsulated payload, to provide a secured packet. The linked-SPI value is filled into the ESP header for use by the destination security endpoint to successfully index into its SAD. The destination endpoint security address is filled into the new header so that the packet reaches the destination security endpoint. The IPsec security processing is now complete, and the packet forwarder 214 sends (328) the protected packet (or secured packet) to the network 102.

When a packet is received from the network, it is first processed by the SAM in the destination security endpoint. If the packet is not protected with IPsec (does not contain an IPsec header), the packet is forward to the SPM. If the packet is protected with IPsec and an SA cannot be found for it, it is discarded. Finally if the packet is protected with IPsec and an appropriate SA is found by indexing the SAD with the SPI, the packet is authenticated, decrypted, and forwarded to the SPM. When the SPM receives a packet from the SAM, it verifies that the policy applied by the SAM matches the policy configured in the SPD. If the policy cannot be verified, the packet is discarded. If the policy can be verified, it is forwarded to the application.

We turn again to the address translations that can be applied in accordance with the teachings herein. In the case of a single encryption gateway encrypting packets to be sent to a large number of SUs, the number of data associations can quickly become difficult to manage. To reduce the number of data associations that must be provisioned, the concept of a “wildcard” value (that identifies an address translation) is added to the Remote Tunnel Endpoint address in the KMM and saved at least into the DAD. Tables 8 and 9 show an example data association for the DEG 110 that makes use of the wildcard. Since an SU will typically only communicate with a small number of DEGs, the use of the wildcard value or address translation can be implemented in their data associations but would provide a less pronounced advantage than the use of the address translation in the DEG.

In one embodiment, the address translation (or wildcard value) comprises a subnet mask in a classless inter-domain routing (CIDR) format or notation, that begins with the Internet Protocol address followed by a “/” character and a decimal number specifying the length, in bits, of the subnet mask or routing prefix. In case of address block specifications, the IP address is the starting address of the block. For example (a more complete IPv4 subnetting reference table is available): 192.168.100.1/24 represents the given IPv4 address and its associated routing prefix (192.168.100.0) or, equivalently, its subnet mask, 255.255.255.0.; 192.168.0.0/22 represents the 1024 IPv4 addresses from 192.168.0.0 through 192.168.3.255; 2001:DB8::/48 represents the IPv6 addresses from 2001:DB8:0:0:0:0:0:0 through 2001:DB8:0:FFFF:FFFF:FFFF:FFFF:FFFF, inclusive; and ::1/128 represents the IPv6 loopback address. For IPv4 networks, an alternative representation uses the network address followed by the network's subnet mask, written in dot-decimal notation: e.g., 192.168.0.0/24 could be written 192.168.0.0/255.255.255.0; or 192.168.0.0/22 could be written 192.168.0.0/255.255.252.0.

The value after the slash indicates a “wildcard” value, which indicates the address translation being used. Tables 8 and 9 below illustrate the use of the CIDR format to indicate the address translation. With respect to Table 8, the address translation comprises the source endpoint performing a function on the retrieved destination endpoint data address to generate the destination endpoint security address so that the retrieved destination endpoint data address is different from the generated destination endpoint security address. With respect to Table 9, the address translation comprises the source endpoint using the retrieved destination endpoint data address as the destination endpoint security address so that the generated destination endpoint security address is the same as the retrieved destination endpoint data address.

TABLE 8

| Source IP Address | Destination IP | | | Dest. | Remote Tunnel | | |
|---|---|---|---|---|---|---|---|
| (or network) | Address | Protocol | Source Port | Port | Endpoint | SLN | Policy |
| 10.1.1.0/24 | 10.1.2.0/24 | Any | Any | 0 | 192.168.2.0/24, | 1 | Process |

With the association shown in Table 8, if a packet is to be sent from 10.1.1.100 to 10.1.2.200, the encryption endpoint will determine the actual remote endpoint address (the destination endpoint security address) by applying the inverse of the mask from the Remote Tunnel Endpoint address field to the Destination IP address of the original (inner) IP packet (which is the destination endpoint data address). This means that 10.1.2.200 is logically ANDed with the inverse of 255.255.255.0, and the resulting value is 0.0.0.200. This value is then logically ORed with the Remote Tunnel Endpoint subnet address, resulting in the final remote endpoint address of 192.168.2.200.

A simpler application of the address translation using the CIDR format is shown in Table 9. Notice that the remote tunnel endpoint address is 0.0.0.0/0, meaning that the destination IP address from the inner IP header should be used as-is in the outer IP header added after IPSec encryption. This could be used, for example, where the data endpoint and the encryption endpoint are the same entity.

TABLE 9

| Source IP | | | | | | | |
|---|---|---|---|---|---|---|---|
| Address (or | Destination IP | | Source | Dest. | Remote Tunnel | | |
| network) | Address | Protocol | Port | Port | Endpoint | SLN | Policy |
| 10.1.1.0/24 | 10.1.2.0/24 | Any | Any | 0 | 0.0.0.0/0 | 1 | Process |

In another embodiment, the translation can be indicated by a simple character such as the “*” shown in the databases of Tables 4-7. The character, for example, may provide an indication to use the destination IP address from the inner IP header as-is in the outer IP header added after IPSec encryption.

In further managing the SAD, the SAM 208 could implement some algorithm to periodically clear entries in the SAD so that only those entries having been used within a certain time period are cached. In this way, the number of SA entries in the SAD at any time is minimized.

As mentioned earlier, the above-described embodiments can be used in either or both the DEG 110 or a mobile endpoint (e.g., the SU 106). Moreover, the implementation of particular databases and the contents of these databases depend on system design. For example, a different embodiment using a different database implementation can be realized without departing from the teachings herein. In another embodiment, that can be implemented in the infrastructure security endpoint (e.g., the DEG 110) or in the mobile security endpoint (e.g., the SU 106), no SAD is created. Instead, the DAD, which has all of the needed message generation information anyway, is used directly during IPsec processing.

Accordingly, when the packet comes in from the application, it is still evaluated by pre-processing logic (e.g., the SPM and SAM) that, upon determining that the packet requires IPsec processing, looks into the DAD to obtain the address translation to apply to the destination endpoint data address to generate the destination endpoint security address. The security endpoint then populates the DAD or some other storage device “just in time” with the generated destination endpoint security address; and obtains and applies the authentication and/or encryption parameters in the DAD associated with the generated destination endpoint security address to the packet, to generate the secured packet. The secured packet has an encrypted payload (where confidentiality is provided) and the appropriate headers, including the ESP header and trailer and the new header with the generated destination endpoint security address, where IPsec ESP is implemented.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for secure packet transmission described herein. The non-processor circuits may include, but are not limited to, a radio receiver, a radio transmitter, signal drivers, clock circuits, power source circuits, and user input devices. As such, these functions may be interpreted as steps of a method to perform the secure packet transmission described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A method for secure packet transmission in a communication system, the method comprising:
at a source endpoint:
receiving a first packet requiring security processing;
retrieving from the first packet a destination endpoint data address for a destination endpoint that is to receive the first packet;
determining an address translation;
applying the address translation to the retrieved destination endpoint data address to generate a destination endpoint security address, and creating an entry in a storage device, wherein the entry corresponds only to the destination endpoint and comprises the generated destination endpoint security address and a set of security parameters;
indexing the storage device to obtain the set of security parameters for security processing of the first packet to generate a secured first packet; and
sending the secured first packet to the destination endpoint.

2. The method of claim 1, wherein the entry further comprises a Security Parameter Index and a source endpoint security address, and the set of security parameters identify a security protocol, an encryption algorithm, an encryption key, an authorization algorithm, and an authorization key.

3. The method of claim 1, wherein the security processing comprises Internet Protocol Security (IPSec) processing.

4. The method of claim 3, wherein the source endpoint comprises a gateway, and the IPSec processing comprises tunnel mode of operation.

5. The method of claim 1, wherein the set of security parameters is received in the source endpoint prior to receiving the first packet.

6. The method of claim 1 further comprising creating a second entry in the storage device corresponding only to the destination endpoint, wherein the second entry comprises the generated destination endpoint security address and the set of security parameters, and wherein the second entry is used for processing an incoming secured packet from the destination endpoint.

7. The method of claim 1, wherein the address translation is included in a data association key management message received in the source endpoint prior to the source endpoint receiving the first packet.

8. The method of claim 1, wherein the address translation comprises a subnet mask in classless inter-domain routing format.

9. The method of claim 1, wherein applying the address translation comprises the source endpoint using the retrieved destination endpoint data address as the destination endpoint security address.

10. The method of claim 1, wherein applying the address translation comprises the source endpoint performing a function on the retrieved destination endpoint data address to generate the destination endpoint security address, wherein the destination endpoint security address is different from the destination endpoint data address.

11. The method of claim 1, wherein creating the entry in the storage device comprises creating the entry in a security association database.

12. The method of claim 1, wherein creating the entry in the storage device comprises creating the entry in a data association database.

13. A device for secure packet transmission in a communication system, the device comprising:
a security association database;
a processing device coupled to the security association database, wherein the processing device:
receives a first packet requiring security processing;
retrieves from the first packet a destination endpoint data address for a destination endpoint that is to receive the first packet;
determines an address translation;
applies the address translation to the retrieved destination endpoint data address to generate a destination endpoint security address, and creates an entry in a storage device, wherein the entry corresponds only to the destination endpoint and comprises the generated destination endpoint security address and a set of security parameters; and
indexes the storage device to obtain the set of security parameters for security processing of the first packet to generate a secured first packet; and
an interface that sends the secured first packet to the destination endpoint.

14. A computer-readable storage element having computer readable code stored thereon for programming a computer to perform a method for secure packet transmission in a communication system, the method comprising:
retrieving, from a first packet that requires security processing, a destination endpoint data address for a destination endpoint that is to receive the first packet;
determining an address translation; and
applying the address translation to the retrieved destination endpoint data address to generate a destination endpoint security address for creating an entry in a storage device, wherein the entry corresponds only to the destination endpoint and comprises the generated destination endpoint security address and a set of security parameters, and wherein the entry is used to obtain the set of security parameters for security processing of the first packet to generate a secured first packet for sending to the destination endpoint.
